(19) United States
(12) Patent Application Publication
(10) Pub. No.: US 2025/0067153 A1
(43) Pub. Date: Feb. 27, 2025

(54) System and Method for Controlling Carbon Sequestration

(71) Applicant: ABB Schweiz AG, Baden (CH)

(72) Inventors: Ian Holden, Welwyn (GB); Riccardo Martini, Genova (IT)

(73) Assignee: ABB Schweiz AG, Baden (CH)

(21) Appl. No.: 18/941,086

(22) Filed: Nov. 8, 2024

Related U.S. Application Data
(63) Continuation of application No. PCT/EP2023/062245, filed on May 9, 2023.

(30) Foreign Application Priority Data
May 13, 2022 (EP) 22173328.0

(51) Int. Cl. E21B 41/00

(52) U.S. Cl. CPC E21B 41/0064; E21B 2200/20

(57) ABSTRACT

A system for controlling carbon sequestration includes at least one emitter, at least one reservoir connected over a pipeline with the at least one emitter and configured to receive and store process fluid; at least one compressor unit configured to control a downstream pressure of the process fluid; at least one valve configured to control a flow of the process fluid; and an optimizer unit configured to: determine emitter output data by continuously logging emitter output levels of the process fluid of the of at least one emitter, determine future emitter output data using the determined emitter output data, and determine optimized control set-points for controlling the sequestration of the process fluid using the determined future emitter output data; wherein the optimized control set-points comprise compressor unit set-points for controlling the at least one compressor, and valve set-points for controlling the at least one valve.

### CROSS-REFERENCE TO RELATED APPLICATIONS

The instant application claims priority to International Patent Application No. PCT/EP2023/062245, filed May 9, 2023, and to European Patent Application No. 22173328.0, filed May 13, 2022, each of which is incorporated herein in its entirety by reference.

### FIELD OF THE DISCLOSURE

The present disclosure relates to a system and a method for controlling carbon sequestration.

### BACKGROUND OF THE INVENTION

In carbon sequestration, the number of process fluid emitters, in particular CO2 emitters, will vary from project to project. The rate of process fluid generation will vary per emitter, typically dependent on factors including time of day, season and product demand. The quantity of emitters may vary over the lifetime of a carbon capture utilization and storage (CCUS) facility. CCUS operators need to store the CO2 utilizing the least and lowest cost energy.

### BRIEF SUMMARY OF THE INVENTION

Based on the foregoing, there is a need for an improved carbon sequestration in view of safety and costs.

According to an aspect, a system for controlling carbon sequestration comprises: At least one emitter, being configured to output a process fluid comprising carbon dioxide that is to be sequestrated. At least one reservoir, being connected over a pipeline with the at least one emitter and being configured to receive and store the process fluid. At least one compressor unit, being disposed at the pipeline between the at least one emitter and the at least one reservoir and being configured to control a downstream pressure of the process fluid. At least one valve, being disposed at the pipeline between the at least one emitter and the at least one reservoir and being configured to control a flow of the process fluid from the at least one emitter to the at least one reservoir. An optimizer unit, being configured to determine emitter output data by continuously logging emitter output levels of the process fluid of the of at least one emitter, wherein the emitter output levels relate to an amount of process fluid. The optimizer unit is configured to determine future emitter output data using the determined emitter output data, wherein the future emitter output data relate to a prediction of emitter outputs in a predetermined time window. The optimizer unit is configured to determine optimized control set-points for controlling the transport of the process fluid using the determined future emitter output data. The optimized control set-points comprise compressor unit set-points and valve set-points, wherein the compressor unit set-points are used for controlling the at least one compressor unit, wherein the valve set-points are used for controlling the at least one valve.

In other words, the optimizer unit is configured to evaluate control set-points, or in other words different valve values and compressor values in view of the predicted future emitter output data and finds optimal control set-points, in particular in view of security and costs. In other words, the optimizer units provides a relationship between different combinations of control set-points in a scenario of the future emitter output data to be sequestrated and costs within received boundaries. This allows the optimizer unit to find the most optimal control-points with the lowest costs for sequestration that also maintain the system within received or predetermined boundaries.

### BRIEF DESCRIPTION OF THE SEVERAL VIEWS OF THE DRAWING(S)

FIG. 1 is a schematic of a system for controlling carbon sequestration in accordance with the disclosure.

FIG. 2 is a schematic of an optimizer unit in accordance with the disclosure.

FIG. 3 is a flowchart for a method for controlling carbon sequestration in accordance with the disclosure.

The reference symbols used in the drawings, and their meanings, are listed in summary form in the list of reference symbols. In principle, identical assembly parts are provided with the same reference symbols in the figures.

Preferably, the functional modules and/or the configuration mechanisms are implemented as programmed software modules or procedures, respectively; however, one skilled in the art will understand that the functional modules and/or the configuration mechanisms can be implemented fully or assembly partially in hardware.

### DETAILED DESCRIPTION OF THE INVENTION

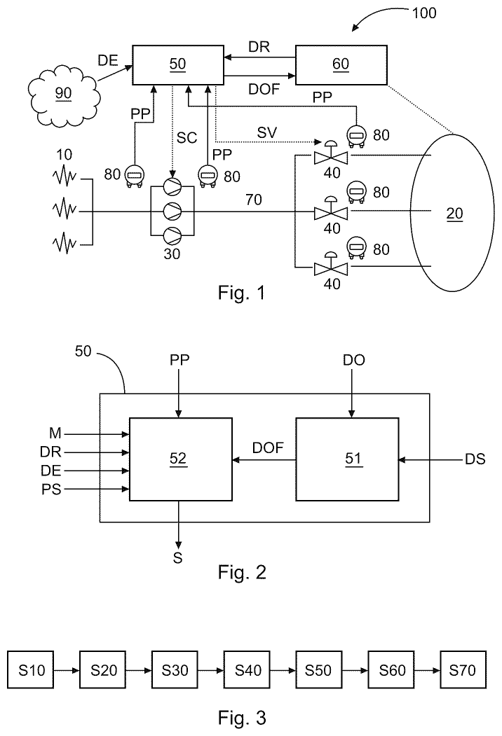

FIG. 1 shows a schematic view of a system 100 for controlling carbon sequestration. The system 100 comprises at least one emitter 10, at least one reservoir 20, at least one compressor unit 30, and at least one valve 40. In this case, the system 100 comprises a plurality, for example three, emitters 10 that are configured to output a process fluid 11 comprising carbon dioxide. The system 100 is configured to sequestrate the process fluid 11 from the emitters 10 to the reservoir 20 that is configured to receive and store the process fluid 11. The reservoir 20 is connected to the emitters 10 via a pipeline 70, in particular a pipeline system that comprises a plurality of branches of pipelines. Between the emitters 10 and the reservoir 20, a plurality of compressor units 30, for example three, are disposed at the pipeline 70. The compressor units 30 apply pressure to the process fluid 11 in the pipeline 70 for transporting the process fluid 11 through the pipeline 70. For example, each branch of pipeline in the pipeline 70 is supplied with a compressor unit 30. The reservoir 20 is accessed by the pipeline 70 over a plurality of wells, which each comprise a valve 40. The valve 40 is configured to control a flow of the process fluid 11 in the pipeline 70 and especially into the well that leads into the reservoir 20.

The carbon sequestration, or in other words the sequestration of the process fluid 11, is controlled by an optimizer unit 50, which is part of the system 100. The optimizer unit 50 is preferably implemented as a software module. In order to control the sequestration of the process fluid 11, the optimizer unit 50 provides optimized control set-points S. The optimized control set-points comprise set-points, or in other words control settings, for the compressor units 30 and the valves 40. As such, the optimizer unit 50 is configured to control the pressure and the flow of the process fluid 11 in the pipeline 70 and furthermore, the optimizer unit 50 is configured to define different paths of the process fluid 11 through the pipeline 70 from the emitters 10 to the reservoir 20 and the amount of process fluid 11 that flows through which path of the pipeline 70. The optimized control set-points S are control set-points S that are optimized by the optimizer unit 50 in particular in view of general transportation cost, energy consumption of the sequestration and maximization of the storage capacity of the reservoir 20 and/or the wells. The optimized control set-points S comprise compressor unit set-points SC that are used for controlling the compressor units 30 and valve set-points SV that are used for controlling the valves 40.

The optimizer unit 50 is configured to continuously monitor, or in other words log, emitter output levels of the process fluid 11 from the emitters 10. In other words, the optimizer unit 50 is configured to monitor the amount of process fluid 11 that is emitted by the emitters 10, in particular over a predetermined time window. Based on the monitoring, the optimizer unit 50 determines emitter output data DO that relate to the emitted process fluid 11. The optimizer unit 50 is further configured to determine future emitter output data DOF using the determined emitter output data DO. In other words, the optimizer unit 50 is configured to predict emitter output levels that will be outputted by the emitters, in particular in a predetermined time window. The optimizer unit 50 might therefore also include scenario data Ds that are supplied to the optimizer unit 50 and comprise general information about the carbon sequestration. In particular, the time and date of the carbon sequestration play a major factor in the prediction of the future emitter output data DOF. Using the determined future emitter output data DOF, the optimizer unit 50 determined the optimized control set-points S, and thus provides an improved carbon sequestration.

Preferably, the optimizer unit 50 comprises a process model that, in particular, is a machine learning model. The process model provides a model of the transportation process of the process fluid 11 from the emitters 10 to the reservoir 20. The process model is configured to provide a prediction of the transportation of the process fluid 11 that is used by the optimizer unit 50 to determine the optimized control set-points.

The system 100 comprises a plurality of process parameter sensors 80 that re configured to determined process parameters PP of the process fluid 11. The process parameters sensors 80 are in particular disposed near the compressor unit 30 and the valves 40. However, the process parameter sensors 80 are disposed along the pipeline 70 wherever the information of the process parameters PP is useful or necessary. The process parameters 70 comprise a fluid pressure, a fluid temperature, a fluid composition and/or a fluid flow of the process fluid 70. The process parameters PP are provided to the optimizer unit 50. The optimizer unit 50 is configured to determine future process parameters using the determined future emitter output data DOF and the determined process parameters PP. The future process parameters are a prediction and/or simulation of the process parameters in a predetermined time window that lies in the future. The process model of the optimizer unit 50 preferably uses the determined process parameters PP and the future emitter output data DOF to determine the future process parameters, in particular based on different compressor unit set-points SC and/or valve set-points SV. In other words, the process model provides simulations for the optimizer unit 50 that predict how based on different scenarios of compressor unit set-points SC and valve set-points SV, the process parameters PP will change. Consequently, the optimizer unit 50 can evaluate, based on the determined future process parameters, which set-points yield a most optimal carbon sequestration, in particular in view of general transportation cost, energy consumption of the sequestration and maximization of the storage capacity of the reservoir 20 and/or the wells. This optimizer unit 50 preferably considers additional factors in the optimization process. For example, the process parameters PP should all apply to provided security constraints. Furthermore, based on the process parameters PP, in particular fluid pressure and fluid temperature, a physical state of the process fluid 11 might change during transportation. A change of physical state of the process fluid 11 usually leads to an increase in energy consumption and as such costs. Thus, phase change margins that relate to physical boundaries of the process parameters PP in view of a change of physical state of the process fluid 11 might be provided to the optimizer unit 50. Thus, the optimizer unit 50 will most likely determine optimized control set-points S that will not lead to a change of physical state of the process fluid 11 during transportation from the emitters 10 to the reservoir 20.

The system 100 further comprises a reservoir model unit 60 that is configured to provide a reservoir model of the reservoir 20 and/or the wells. The reservoir model 60 provides reservoir data DR based on the future emitter output data DOF and/or the future process parameters. Thus, the optimizer unit 50 can determined the optimized control set-points S using the reservoir data DR.

In order to evaluate the costs of the carbon sequestration, the optimizer unit 50 is provided with energy cost data DE from an external data source 90, for example a cloud environment. The energy cost data DE preferably comprise future energy costs. In other words, the energy cost data DE reflect predicted energy costs in a future predetermined time frame of carbon sequestration. Consequently, the optimizer unit 50 is configured to determine the optimized control set-points S using the energy costs data DE.

FIG. 2 shows a schematic view of an optimizer unit 50. The optimizer unit 50 comprises an emitter analysis unit 51 and a set-point analysis unit 52. The emitter analysis unit 51 is provided with emitter output data DO and scenario data DS in order to provide future emitter output data DOF. The future emitter output data DOF is provided to the set-point analysis unit 52. The set-point analysis unit 52 is also supplied with process parameters PP, phase change margins M, reservoir data DR, energy cost data DE and safety parameters PS. The set-point analysis unit 52 is configured to provide optimized control set-points S based on all the available inputs.

FIG. 3 shows a schematic view of a method for controlling carbon sequestration comprising the follow steps: Outputting S10, by at least one emitter 10, a process fluid 11 that is to be captured. Receiving and storing S20, by at least one reservoir 20, being connected over a pipeline 70 with the at least one emitter 10, the process fluid 11, Controlling S30, by at least one compressor unit 30, being disposed at the pipeline 70 between the at least one emitter 10 and the at least one reservoir 20, a downstream pressure of the process fluid 11. Controlling S40, by at least one valve 40, being disposed at the pipeline 70 between the at least one emitter 10 and the at least one reservoir 20, a flow of the process fluid 11 from the at least one emitter 10 to the at least one reservoir 20. Determining S50, by an optimizer unit 50, emitter output data DO by continuously logging emitter output levels of the of at least one emitter 10, wherein the emitter output levels relate to an amount of process fluid 11. Determining S60, by the optimizer unit 50, future emitter output data DOF using the determined emitter output data DO, wherein the future emitter output data DOF relate to a prediction of emitter outputs in a predetermined time window. Determining S70, by the optimizer unit 50, optimized control set-points S for controlling the transport of the process fluid 11 using the determined future emitter output data DOF. The optimized control set-points S comprise compressor unit set-points DC and valve set-points SV, wherein the compressor unit set-points SC are used for controlling the at least one compressor unit 30, wherein the valve set-points SV are used for controlling the at least one valve 40.

Preferably, the at least one reservoir relates to any storage geological formation that is suitable for permanently storing the process fluid, in particular CO2. Furthermore, the at least one reservoir comprises an aquifer. In particular, each reservoir is accessed by the pipeline via a valve that allows to regulate the flow of the process fluid into the reservoir. Further preferably, each reservoir is accessed by at least one well that connects the pipeline with the reservoir. In this case, each of the at least one wells comprise a valve that allows to regulate the flow of the process fluid into the well and as such into the reservoir.

Preferably, the optimizer unit comprises a pipeline model, wherein the pipeline model relates to a virtual representation of the pipelines. Further preferably, the optimizer unit uses the pipelines model to determine the optimized control set-points. In other words, the optimizer unit uses the information that the pipeline model provides to evaluate how process parameters of the process fluid would most likely behave depending on different control set-points and the determined future emitter output data.

Preferably, the optimizer-unit is implemented in software. The optimized set-points are either provided to an operator as recommend operational set-points or are automatically applied to a control system, in particular a level 2 control system for automatic optimization of the sequestration.

Furthermore, the pipeline model comprises pipeline integrity data relating to an integrity of the pipeline. In other words, if the integrity of a pipeline, in particular of a branch of the pipeline, falls under a predetermined threshold, this path is temporary omitted during fluid sequestration. For example, due to over pressure in the pipeline, the pipeline integrity falls under the predetermined threshold. Thus, this pipeline is no longer used for fluid sequestration, even when it means that a subsequent reservoir cannot be used for fluid sequestration.

Consequently, an improved system for controlling fluid sequestration is provided. In other words, the system allows dynamic operational and maintenance planning. Furthermore, the system can perform the fluid sequestration in light of costs, in particular energy costs. Thus, the system allows to provide a process fluid sequestration with maximization of storage capacity of the reservoir and minimization of costs, in particular energy costs.

In a preferred embodiment, the system comprises at least one process parameter sensor, configured to determine process parameters of the process fluid. The optimizer unit is configured to determining future process parameters using the determined future emitter output data and the determined process parameters, wherein the future process parameters relate to prediction of the process parameters in a predetermined time window. The optimizer unit is configured to determine the optimized control set-points using the determined future process parameters.

In other words, based on the future emitter output data, the optimizer unit is aware of the amount of process fluid that needs to be sequestrated in a given future time window. Using this information, the optimizer unit is configured to determine how the process parameters will change when sequestrating the process fluid in accordance with the future emitter output data depending on the optimized control set-points. Thus, the optimizer unit is configured to determine optimized control set-points that lead to process parameters with the lowest costs. In particular, control set-points that lead to a relatively high pressure of the process fluid, usually lead to relatively high costs, as high pressure during sequestration leads to a high energy consumption of the at least one compressor unit.

The optimizer preferably comprises a process model that is configured to determine the future process parameters. For example, the optimizer unit allows to minimize compressor energy usage by trimming compressor power while keeping valve opening for each well/reservoir below an operator-defined limit. The energy minimization will be performed while honoring valve position constraints so to make sure local pressure control ability is maintained while minimizing the overall energy consumption. The process model preferably comprises a machine learning model.

Preferably, the system comprises a process accumulation infrastructure that provides intermediate storage capacity of the process fluid. The optimizer unit determines the optimized control set-points using the process accumulation infrastructure. In other words the optimizer unit utilizes this intermediate storage capacity to influence operational decisions.

This allows a sequestration of the process fluid that can be optimized in view of a predicted amount of process fluid to be sequestrated and in view of predicted process parameters that the sequestration will lead to.

In a preferred embodiment, the process parameters comprise a fluid pressure, a fluid temperature, a composition and/or a fluid flow.

In a preferred embodiment, the optimizer unit is configured receive phase change margins of the process fluid, relating to physical boundaries of the process parameters of the process fluid in view of a change of physical state of the process fluid. The optimizer unit is configured to determine the optimized control set-points using the received phase change margins.

Preferably, the process fluid, in particular comprising CO2, might have different physical states depending on temperature and pressure of the process fluid. In general, during transport of the process fluid, or in other words during sequestration of the process fluid, no change of physical state of the process fluid should occur. Consequently, depending on provided phase change margins of the process fluid, and the future process parameters of the process fluid, the optimizer unit can determined optimized control set-points that allow a sequestration without a change of physical state of the process fluid.

Process fluid emissions and storage are always balanced to keep pressure in the desired range along the pipeline, especially for gas phase cases of the process fluid due to the need to control gas packing phenomena. In general, the optimizer unit estimates pressure, temperature and composition of the process gas along the pipeline to calculate the margin from phase change.

In other words, a change of physical state of the process fluid during sequestration would most likely lead to relatively high costs and raises security problems. Consequently, the optimizer unit is configured to determine optimized control set-points that lead to a stable physical state of the process fluid.

In a preferred embodiment, the at least one process parameter sensor is disposed on the at least one compressor unit and/or the at least one reservoir.

In a preferred embodiment, the optimizer unit is configured to receive scenario data, relating to general information about the carbon sequestration. The optimizer unit is configured to determine the future emitter output data using the scenario data.

Preferably, the scenario data, as used herein, comprise a time of day, a season and/or a product demand. Those factors relate to the amount of emitting process fluid. For example, during the day, generally, more process fluid is emitted that needs to be sequestrated compared to night time.

In a preferred embodiment, the system comprises a reservoir model unit, being configured to provide a reservoir model of the at least one reservoir and being configured to determine reservoir data using the reservoir model and the determined future emitter output data, wherein the reservoir data relates to properties of the at least one reservoir when receiving process fluid according to the future emitter output data. The optimizer unit is configured to determine the optimized control set-points using the determined reservoir data.

The reservoir model preferably comprises a virtual representation of the at least one reservoir. The reservoir data provided by the reservoir model for example comprise a reservoir life or a maximum or present storage capacity. For example, the amount of pressure needed to store the process fluid into the reservoir relates to a filling level of the reservoir. In other words, a high filling level of the reservoir relates to a higher pressure needed to fill the reservoir with additional process fluid. Higher pressure of the process fluid directly leads to higher costs of the sequestration.

Furthermore, the reservoir data comprises reservoir integrity data, relating to an integrity of the reservoir. In other words, the optimized set-points can be determined in view of the integrity of the available reservoirs. For example, if an integrity of one reservoir falls under a predetermined threshold, in fluid sequestration, this reservoir is temporary omitted.

The reservoir model is preferably configured to determine the reservoir data using the determined future process parameters. In other words, the reservoir model predicts the properties of the at least one reservoir based on the expected emitter output of the emitters and the expected process parameters of specific transportation scenarios.

Consequently, information about the reservoir can be used by the optimizer unit to find the optimized control set-points for sequestration.

In a preferred embodiment, the system comprises a plurality of compressor units, wherein the optimizer unit is configured to balance a workload of the plurality of compressor units between each other when determining the optimized control set-points.

Balancing the workload of the plurality of compressor units directly leads to a reduction of maximum pressure of the process fluid. This directly leads to reduced costs of sequestration.

Consequently, the optimizer units can provide better optimized control set-points by balancing the compressor set-points.

In a preferred embodiment, the system comprises a plurality of reservoirs, wherein the optimizer unit is configured to balance a receiving load of the process fluid between the plurality of reservoirs when determining the optimized control set-points.

As already described, less energy is needed to fill a reservoir that is less filled than an almost full reservoir. Considering the filling level of the reservoir and balancing the receiving load of the process fluid between the available reservoirs allows for improved optimized set-points.

Consequently, the optimizer units can provide better optimized control set-points by balancing the valve set-points.

In a preferred embodiment, the at least on reservoir comprises at a plurality of injection wells that are used to inject the process fluid from the at least one emitter into the at least one reservoir, wherein the optimizer unit is configured to balance a receiving load of the process fluid between the plurality of injection wells when determining the optimized control set-points.

Thus, a wellhead pressure, relating to a pressure in a head of the well, can be controlled.

In a preferred embodiment, the optimizer unit is configured to receive energy cost data; and wherein the optimizer unit is configured to determine the optimized control set-points using the received energy cost data.

In other words, the optimizer unit is provided with current energy prices and/or future price estimations. Consequently, the optimizer unit can allocate the process fluid on wells while balancing reservoir utilization over a selectable time horizon, like a week, in view of the energy costs. The optimizer for example favors a use of less energy consuming wells and/or reservoirs, considering backpressure and distance of the pipeline, when energy prices are high and use wells and/or reservoirs that cause higher energy consumption when prices are low, therefore minimizing energy costs.

In a preferred embodiment, the optimizer unit is configured to receive safety parameters; and wherein the optimizer unit is configured to determine the optimized control set-points using the received safety parameters.

In other words, safety parameters for all transportation, compression facilities, wells and reservoirs are boundary conditions within the optimization of the optimizer unit.

Thus, the system allows to provide a process fluid sequestration with improved safety, in particular in combination with maximization of storage capacity of the reservoir and minimization of costs.

In a preferred embodiment, the system comprises a temperature regulating device, which is configured to externally regulate a temperature of the process fluid. The optimizer unit is configured to determine a temperature control signal when determining the optimized control set-points. The temperature regulating device is configured to regulate the temperature of the process fluid using the temperature control signal.

In a preferred embodiment, the optimizer unit comprises a machine learning unit.

Preferably, the optimizer uses Physical Modelling, Advanced Process Control, Model Predictive Control and/or Artificial Intelligence including Machine Learning.

According to an aspect of the invention, a method for controlling process fluid sequestration comprises the steps: Outputting, by at least one emitter, a process fluid that is to be captured. Receiving and storing, by at least one reservoir, being connected over a pipeline with the at least one emitter, the process fluid. Controlling, by at least one compressor unit, being disposed at the pipeline between the at least one emitter and the at least one reservoir, a downstream pressure of the process fluid. Controlling, by at least one valve, being disposed at the pipeline between the at least one emitter and the at least one reservoir, a flow of the process fluid from the at least one emitter to the at least one reservoir. Determining, by an optimizer unit, emitter output data by continuously logging emitter output levels of the at least one emitter, wherein the emitter output levels relate to an amount of process fluid. Determining, by the optimizer unit, future emitter output data using the determined emitter output data, wherein the future emitter output data relate to a prediction of emitter outputs in a predetermined time window. Determining, by the optimizer unit, optimized control set-points for controlling the transport of the process fluid using the determined future emitter output data. The optimized control set-points comprise compressor unit set-points and valve set-points, wherein the compressor unit set-points are used for controlling the at least one compressor unit, wherein the valve set-points are used for controlling the at least one valve.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SYMBOLS

100 system
10 emitter
11 process fluid
20 reservoir
30 compressor unit
40 valve
50 optimizer unit
51 emitter analysis unit
52 set-point analysis unit
60 reservoir model unit
70 pipeline
80 parameter sensor
90 external data source
SO optimized control set-points
SC compressor unit set-point
SV valve set-point
DO emitter output data
DOF future emitter output data
PP process parameters
M phase change margins
DR reservoir data
DE energy cost data
PS safety parameters
DS scenario data

What is claimed is:

1. A system for controlling carbon sequestration, comprising:
at least one emitter configured to output a process fluid comprising carbon dioxide that is to be sequestrated;
at least one reservoir connected over a pipeline with the at least one emitter and configured to receive and store the process fluid;
at least one compressor unit disposed along the pipeline between the at least one emitter and the at least one reservoir, the at least one compressor unit configured to control a downstream pressure of the process fluid;
at least one valve disposed at the pipeline between the at least one emitter and the at least one reservoir, the at least one valve configured to control a flow of the process fluid from the at least one emitter to the at least one reservoir;
an optimizer unit configured to determine emitter output data by continuously logging emitter output levels of the process fluid of the of at least one emitter, wherein the emitter output levels relate to an amount of process fluid;
wherein the optimizer unit is further configured to determine future emitter output data using the determined emitter output data, wherein the future emitter output data relates to a prediction of emitter outputs in a predetermined time window;
wherein the optimizer unit is further configured to determine optimized control set-points for controlling the sequestration of the process fluid using the determined future emitter output data;
wherein the optimized control set-points comprise compressor unit set-points and valve set-points, wherein the compressor unit set-points are used for controlling the at least one compressor unit, and wherein the valve set-points are used for controlling the at least one valve.

2. The system of claim 1, further comprising at least one process parameter sensor configured to determine process parameters of the process fluid, wherein the optimizer unit is further configured to determining future process parameters using the determined future emitter output data and the determined process parameters, wherein the future process parameters relate to a prediction of the process parameters in a predetermined time window;
and wherein the optimizer unit is further configured to determine the optimized control set-points using the determined future process parameters.

3. The system of claim 2, wherein the process parameters comprise a fluid pressure, a fluid temperature, a composition and/or a fluid flow.

4. The system of claim 2, wherein the optimizer unit is further configured to receive phase change margins of the process fluid relating to physical boundaries of the process parameters of the process fluid in view of a change of physical state of the process fluid; and wherein the optimizer unit is further configured to determine the optimized control set-points using the received phase change margins.

5. The system of claims 2, wherein the at least one process parameter sensor is disposed on the at least one compressor unit and/or the at least one reservoir.

6. The system of claim 1, wherein the optimizer unit is further configured to receive scenario data relating to general information about the carbon sequestration; and
wherein the optimizer unit is further configured to determine the future emitter output data using the scenario data.

7. The system of claim 1, further comprising a reservoir model unit configured to provide a reservoir model of the at least one reservoir, and further configured to determine reservoir data using the reservoir model and the determined future emitter output data, wherein the reservoir data relates to properties of the at least one reservoir when receiving the process fluid according to the future emitter output data; wherein the optimizer unit is further configured to determine the optimized control set-points using the determined reservoir data.

8. The system of claim 1, further comprising a plurality of compressor units, wherein the optimizer unit is further configured to balance a workload of the plurality of compressor units between each other when determining the optimized control set-points.

9. The system of claim 1, further comprising a plurality of reservoirs, wherein the optimizer unit is further configured to balance a receiving load of the process fluid between the plurality of reservoirs when determining the optimized control set-points.

10. The system of claim 1, wherein the at least on reservoir comprises a plurality of injection wells that are used to inject the process fluid from the at least one emitter into the at least one reservoir, wherein the optimizer unit is configured to balance a receiving load of the process fluid between the plurality of injection wells when determining the optimized control set-points.

11. The system of claim 1, wherein the optimizer unit is further configured to receive energy cost data; and wherein the optimizer unit is further configured to determine the optimized control set-points using the received energy cost data.

12. The system of claim 1, wherein the optimizer unit is further configured to receive safety parameters; and wherein the optimizer unit is further configured to determine the optimized control set-points using the received safety parameters.

13. The system of claim 1, further comprising:
a temperature regulating device configured to externally regulate a temperature of the process fluid;
wherein the optimizer unit is further configured to determine a temperature control signal when determining the optimized control set-points; and
wherein the temperature regulating device is configured to regulate the temperature of the process fluid using the temperature control signal.

14. The system of claim 1, wherein the optimizer unit comprises a machine learning unit.

15. A method for controlling process fluid sequestration, comprising:
outputting by at least one emitter a process fluid that is to be captured;
receiving and storing the process fluid by at least one reservoir being connected over a pipeline with the at least one emitter;
controlling a downstream pressure of the process fluid by at least one compressor unit being disposed at the pipeline between the at least one emitter and the at least one reservoir;
controlling a flow of the process fluid from the at least one emitter to the at least one reservoir by at least one valve disposed along the pipeline between the at least one emitter and the at least one reservoir;
determining emitter output data by an optimizer unit by continuously logging emitter output levels of the of at least one emitter, wherein the emitter output levels relate to an amount of process fluid;
determining, by the optimizer unit, future emitter output data using the determined emitter output data, wherein the future emitter output data relate to a prediction of emitter outputs in a predetermined time window;
determining, by the optimizer unit, optimized control set-points for controlling the transport of the process fluid using the determined future emitter output data;
wherein the optimized control set-points comprise compressor unit set-points and valve set-points, wherein the compressor unit set-points are used for controlling the at least one compressor unit, and wherein the valve set-points are used for controlling the at least one valve.
